(19) United States
(12) Patent Application Publication
(10) Pub. No.: US 2009/0313078 A1
(43) Pub. Date: Dec. 17, 2009

(54) Hybrid human/computer image processing method

(76) Inventor: Geoffrey (Mark, Timothy) CROSS, Oxford (GB)

Correspondence Address: MILAN M. POPOVICH, 53 WESTFIELD ROAD, LEICESTER, EN, LE3 6HU, GB

(21) Appl. No.: 12/457,131

(22) Filed: Jun. 2, 2009

(30) Foreign Application Priority Data
Jun. 12, 2008 (GB) GB0810737.7

(51) Int. Cl. G06Q 10/00; G06K 9/62

(52) U.S. Cl. 705/9; 382/209

(57) ABSTRACT

There is provided a hybrid human/computing arrangement which advantageously involves humans in the process of scrutinizing video image frames and processing said video image frames to detect and characterize objects of interest while ignoring other features of said image frame. The invention overcomes the problems of missed and false detections by humans. Said features of interest may comprise equipment and installations found on or in the vicinity of roads including road signs of the type commonly used for traffic control, warning, and informational display.

### BACKGROUND OF THE INVENTION

The present invention relates generally to the field of image processing and in particular to hybrid distributed computing using at least one human to assist a computer in the identification of objects depicted in video image frames.

The present invention has been developed to identify roadside equipment and installations and road signs of the type commonly used for traffic control, warning, and informational display. There is a need to provide an efficient, cost effective method for rapidly scrutinizing a video image frame and processing an image frame to detect and characterize features of interest while ignoring other features of said image frame.

Automatic methods for processing video image frames and classifying and cataloging objects of interest depicted in said video frames have been developed. Such technology continues to be one of the goals of artificial intelligence research. Many examples of methods developed for a range of applications are to be found in the patent literature. Prior art apparatus typically comprises a camera of known location or trajectory configured to survey a scene including one or more calibrated target objects, and at least one object of interest. Typically, the camera output data is processed by an image processing system configured to match objects in the scene to pre-recorded object image templates.

Several prior patents have been directed at the automatic detection and classification of road signs.

U.S. Pat. No. 5,633,944 entitled “Method and Apparatus for Automatic Optical Recognition of Road Signs” issued May 27, 1997 to Guibert et al. and assigned to Automobiles Peugeot, discloses a system for recognizing signs wherein a source of coherent radiation, such as a laser, is used to scan the roadside. Such approaches suffer from the problems of optical and mechanical complexity and high cost.

U.S. Pat. No. 5,627,915 entitled “Pattern Recognition System Employing Unlike Templates to Detect Objects Having Distinctive Features in a Video Field,” issued May 6, 1997 to Rosser et al. and assigned to Princeton Video Image, Inc. of Princeton, N.J., discloses a method for rapidly and efficiently identifying landmarks and objects using templates that are sequentially created and inserted into live video fields and compared to a prior template(s). This system requires specific templates of real world features and does not operate on unknown video data. Hence the invention suffers from the inherent variability of lighting, scene composition, weather effects, and placement variation from said templates to actual conditions in the field.

U.S. Pat. No. 7,092,548 entitled “Method and apparatus for identifying objects depicted in a video stream” assigned to Facet Technology discloses techniques for building databases of road sign characteristics by automatically processing vast numbers of frames of roadside scenes recorded from a vehicle. By detecting differentiable characteristics associated with signs the portions of the image frame that depict a road sign are stored as highly compressed bitmapped files. Frames lacking said differentiable characteristics are discarded. Sign location is derived from triangulation, correlation, or estimation on sign image regions. The novelty of 548' patent lies in detecting objects without having to rely on continually tuned single filters and/or comparisons with stored templates to filter out objects of interest. The method disclosed in the 548' patent suffers from the need to process vast amounts of data.

While automatic solutions offer the potential for greater speed, efficiency and lower cost the prior art suffers from the problems of high error probability and slow processing speeds. There is a more fundamental problem that object recognition is still difficult for a computer processor to perform. While it may be a straightforward task for a human to identify road signs in an image, automating the same task on a computer presents a complex mathematical problem even if many computer processors are combined in a distributed computer network or some other computer architecture. Representing human knowledge in a form that computers can understand and use and transferring the information processing methods used by the human computers are still major challenges for artificial intelligence.

Thus, better methods and apparatuses are needed to help solve the type of problems that tend to be almost trivial for humans but difficult to automate using computers.

Traditionally, tasks involving the recognition of objects in images have been accomplished by using workers with appropriate training. Another solution for using human operators is inspired by a mechanical chess-playing automaton known as the Mechanical Turk invented in 1769 by a Hungarian nobleman Wolfgang von Kempelen. The Mechanical Turk apparently used artificial intelligence to defeat its opponents but in fact relied on a human chess master concealed within the apparatus.

The Mechanical Turk provides a paradigm for business method based on using a human workforce to perform tasks in a fashion that is indistinguishable from artificial intelligence. The principle of the mechanical Turk is currently being exploited by Amazon Technologies Inc as part of its range of web services.

U.S. Pat. No. 7,197,459 by Harinarayan et al, assigned to Amazon Technologies Incorporated entitled “Hybrid machine/human computing arrangement” discloses a hybrid machine/human computing arrangement in which humans assist a computer in solving particular tasks. In one embodiment, a computer system decomposes a task into subtasks for human performance. Tasks are dispatched from a command and control centre via a central coordinating server to personal computers operated by a widely distributed, on-demand workforce. The tasks are referred to as Human Intelligence Tasks or “HITs”. The humans perform the HITs and despatch the results to the server, which generates a result based at least in part on the results of the human performances. HITs may include the specific output desired, the format of the output, the definition of the tasks and fee basis. There is no reasonable limited to the number of HITs that may be loaded into the marketplace. The controller only pays for satisfactorily completed work.

A similar application to Amazon's, with much narrower scope, developed by the Google Corporation (California) known as Google Answers provided a knowledge market that allowed users to post bounties for well-researched answers to their queries.

Although humans tend to be more adept than computers at simple tasks such as detecting objects in images they are prone to missed or invalid detections due to lapses in concentration, inadequate understanding of the HIT requirement, and corruption of video data or other causes.

There is requirement for a hybrid human/computing arrangement which advantageously involves humans in the process of scrutinizing video image frames and processing said image frames to detect and characterize features of interest while ignoring other features of said image frame.

There is a further requirement for a hybrid human/computing arrangement which advantageously involves humans in the process of scrutinizing video image frames and processing said image frames to detect and characterize features of interest while ignoring other features of said image frame and overcomes the problems of missed and false detections by humans.

There is further requirement for a hybrid human/computing arrangement which advantageously involves humans in the process of scrutinizing video image frames and processing said image frames to detect and characterize features of interest while ignoring other features of said image frame and overcomes the problems of missed and false detections by humans, wherein said features of interest comprise equipment and installations found on or in the vicinity of roads including road signs of the type commonly used for traffic control, warning, and informational display.

### SUMMARY OF THE INVENTION

It is a first object of the present invention to provide a hybrid human/computing arrangement which advantageously involves humans in the process of scrutinizing digitized video image frames and processing said image frames to detect and characterize features of interest while ignoring other features of said image frame.

It is a further object of the present invention to provide a hybrid human/computing arrangement which advantageously involves humans in the process of scrutinizing video image frames and processing said image frames to detect and characterize features of interest while ignoring other features of said image frame and overcomes the problems of missed and false detections by humans.

It is a further object of the present invention to provide a hybrid human/computing arrangement which advantageously involves humans in the process of scrutinizing video image frames and processing said image frames to detect and characterize features of interest while ignoring other features of said image frame and overcomes the problems of missed and false detections by humans, wherein said features of interest comprise equipment and installations found on or in the vicinity of roads including road signs of the type commonly used for traffic control, warning, and informational display

A method of detecting objects in a video sequence in accordance with the basic principles of the invention comprises the following steps.

In a first step a video data source is provided.

In a second step a centre comprising a central coordinating server for defining and coordinating sub tasks to be performed by humans is provided.

In a third step first set of workers comprising humans equipped with computer workstations and linked to said center via the internet is provided.

In a fourth step an input video sequence containing images of objects of interest is transmitted to the centre from the video data source

In a fifth step the centre configures the input video sequence into a first set of Human Intelligence Tasks (HITs) each said HIT comprising a set of frames sampled from the input video sequence.

In a sixth step the centre despatches said HITs to the workstations of said workers.

In a seventh step each worker searches their allotted set of frames, one frame at a time, for objects of interest defined by the centre, said objects being selected using a computer data entry operation. The data entry operation is desirably a mouse point and click operation.

In an eighth step each worker transmits a click to the centre signifying a detection of an object of interest.

In a ninth step the centre clusters said object detections into groups of detections associated with objects of interest.

In a tenth step the center re-transmits HITs to workers that have failed to deliver a predetermined number of detections with the workers repeating the seventh to ninth steps until the requisite number of detections has been achieved and the object detection is deemed valid or the number of presentations of the HITs exceeds a predefined number in which case the object detection is deemed false.

In a eleventh step the centre computes 3D location coordinates for each object detected using the pooled set of detections collected by the workers

A method of assigning attributes the objects detected using the above described first to eleventh steps comprises the following additional steps.

In a twelfth step the centre annotates each frame deemed to contain objects of interest by inserting a symbol at each image point corresponding to a computed 3D location.

In a thirteenth step the centre configures the annotated frames as a second set of HITs for distribution to a second set of workers.

In a fourteenth step the centre the second set of HITs is despatched to the workers.

In a fifteenth step a database of sign images is provided by the centre and displayed within a menu at the workstation of each worker.

In a sixteenth step each worker clicks on the database image that most closely matches the object in each annotated frame, each database image selection being logged at the centre.

In a seventeenth step database image selections logged by the centre are pooled for each annotated frame object

In a eighteenth step the pooled database image selections for each annotated frame object are analysed to identify the database image with the highest score.

In a nineteenth step the attributes of the highest scoring database image are assigned to each annotated frame object.

In one embodiment of the invention the data entry operation used in the seventh step may be carried out by means of a touch screen.

In one embodiment of the invention the centre performs the functions of task definition and HIT allocation.

In one embodiment of the invention the centre performs the functions of task definition, HIT allocation and at least one of worker payment, worker scoring and worker training.

In one embodiment of the invention the video data source comprises at least one vehicle-mounted camera.

In one embodiment of the invention the video data source comprises at least one fixed camera installation.

In one embodiment of the invention the input video sequence is divided into a multiplicity of video sub sequences sampled in such a way that each worker analyses frames spanning the entire input video sequence, wherein each said input video sub sequence is allocated to a separate worker.

In one embodiment of the invention the video sequence is augmented with location data provided by at least one of Global Positioning System (GPS) or Differential Global Positioning System (d-GPS) transponder/receiver, or relative position via Inertial Navigation System (INS) systems, or a combination of GPS and INS systems.

In one embodiment of the invention the HITs comprise video image frames annotated with information relating to the 3D locations of objects in scenes depicted in said frames.

In one embodiment of the invention the input video sequence may be digitized prior to delivery to the centre.

In one embodiment of the invention the input video sequence may be digitized at the centre.

In one embodiment of the invention the workers comprises unqualified workers.

In one embodiment of the invention the workers comprise qualified workers.

In one embodiment of the invention the workers work in association with an automatic image processing system.

In one embodiment of the invention the second set of workers may be identical to said first set of workers.

In one embodiment of the invention the first set of workers is unqualified and said second set of workers is qualified.

In one embodiment of the invention the analysis of pooled object detections is performed automatically at the centre.

In one embodiment of the invention the centre is a business entity.

In one embodiment of the invention the centre is a business entity and the workers are employees thereof. In such embodiments of the invention workers carry out tasks as part of their normal duties without requiring payment for said tasks.

In one embodiment of the invention the centre is a computer system.

In one embodiment of the invention the objects are road signs.

In one embodiment of the invention the objects comprise at least one of signs, equipment and installations deployed on or near to roads

In one embodiment of the invention a worker is one of university educated, at most secondary school educated, and not formally educated.

In one embodiment of the invention the HIT is associated with multiple attributes related to performance of said task, the attributes comprising at least one of an accuracy attribute, a timeout attribute, a maximum time spent attribute, a maximum cost per task attribute, and a maximum total cost attribute.

In one embodiment of the invention the dispatching of HITs by the centre is performed using a defined application-programming interface.

In one embodiment of the invention the dispatching of HITs to a worker includes providing an indication to the worker of the payment to be provided for performance of the HIT if the worker chooses to perform the HIT.

In one embodiment of the invention the providing of the payment to a worker is performed in response to the receiving from the worker of the first result from the performance of the HIT.

In one embodiment of the invention the payment provided to a worker for the performance of the HIT is based at least in part on the quality of the performance of the HIT.

In one embodiment of the invention the allocation of HITs to individual workers may be determined by the quality of performance of earlier HITs by said worker.

In one embodiment of the invention the payment provided to a worker is based at least in part on the past quality of performance of HITs by the worker.

In one embodiment of the invention the dispatching of the HIT to the worker includes providing an indication to the worker of the level of compensation associated with performance of the HIT.

In one embodiment of the invention the attributes assigned to objects in the twelfth to nineteenth steps comprise matches to specific signs depicted in traffic sign reference manuals.

In one embodiment of the invention the attributes assigned to objects in the twelfth to nineteenth steps comprise similarity to specific signs depicted in the Traffic Signs Manual published by the United Kingdom Department for Transport.

In one embodiment of the invention the attributes assigned to objects in the twelfth to nineteenth steps comprise membership of a particular class of signs.

In one embodiment of the invention the attributes assigned to objects in the twelfth to nineteenth steps comprise membership of a class of signs within a hierarchy of signs.

A more complete understanding of the invention can be obtained by considering the following detailed description in conjunction with the accompanying drawings wherein like index numerals indicate like parts. For purposes of clarity details relating to technical material that is known in the technical fields related to the invention have not been described in detail.

### BRIEF DESCRIPTION OF THE DRAWINGS

FIG. 1A is a flow diagram illustrating one embodiment of the invention.

FIG. 1B is a flow diagram illustrating one embodiment of the invention.

FIG. 1C is a flow diagram illustrating one embodiment of the invention.

FIG. 1D is a flow diagram illustrating one embodiment of the invention.

FIG. 1E is a flow diagram illustrating one embodiment of the invention.

FIG. 1F is a flow diagram illustrating one embodiment of the invention.

FIG. 1G is a flow diagram illustrating one embodiment of the invention.

FIG. 1H is a flow diagram illustrating one embodiment of the invention.

FIG. 1I is a flow diagram illustrating one embodiment of the invention.

FIG. 1J is a flow diagram illustrating one embodiment of the invention.

FIG. 2 is a method of sampling video data for use in the invention.

FIG. 3 is a flow diagram illustrating the process for detecting objects and 3D locations thereof in one embodiment of the invention.

FIG. 4 is a flow diagram illustrating the process used in one embodiment of the invention for assigning attributes to detected objects.

FIG. 5A is a table representing the results of the determination of object attributes using the process illustrated in FIG. 4.

FIG. 5B is a chart representing the results of the determination of object attributes using the process illustrated in FIG. 4.

FIG. 6 is a flow diagram showing the steps used in the process of FIG. 4

FIG. 7 is a flow diagram showing the steps used in the process of FIG. 5

FIG. 8 is a flow diagram illustrating a worker remuneration process used in one embodiment of the invention.

FIG. 9 is a flow diagram illustration a processing scheme used in one embodiment of the invention.

### DETAILED DESCRIPTION OF THE INVENTION

It is a first object of the present invention to provide a hybrid human/computing arrangement which advantageously involves humans in the process of scrutinizing video image frames and processing said image frames to detect and characterize features of interest while ignoring other features of said image frame.

It is a further object of the present invention to provide a hybrid human/computing arrangement which advantageously involves humans in the process of scrutinizing video image frames and processing said image frames to detect and characterize features of interest while ignoring other features of said image frame and overcomes the problems of missed and false detections by humans.

It is a further object of the present invention to provide a hybrid human/computing arrangement which advantageously involves humans in the process of scrutinizing video image frames and processing said image frames to detect and characterize features of interest while ignoring other features of said image frame and overcomes the problems of missed and false detections by humans, wherein said features of interest comprise equipment and installations found on or in the vicinity of roads including road signs of the type commonly used for traffic control, warning, and informational display

It will be apparent to those skilled in the art that the present invention may be practiced with only some or all aspects of the present invention as disclosed in the present application. In the following description well-known features of computer systems have been omitted or simplified in order not to obscure the basic principles of the invention.

Parts of the following description will be presented using terminology commonly employed by those skilled in the art, such as: data, communications link, computer program, database, server, point-and-click, mouse, workstation and so forth.

In the following description of the invention and the claims the term “click” refers both to the piece of information generated by the action of moving a mouse controlled cursor over an object of interest displayed on a computer screen and pressing and releasing the mouse button and to the action of pressing and releasing the mouse button.

For the purpose of explaining the invention certain operations will be described as multiple discrete steps performed in turn. However, the order of description should not be construed as to imply that these operations are necessarily performed in the order they are presented, or order dependent. Indeed certain steps may be performed simultaneously.

It should also be noted that in the following description of the invention repeated usage of the phrases “in one embodiment” or “in certain embodiments” does not necessarily refer to the same embodiment.

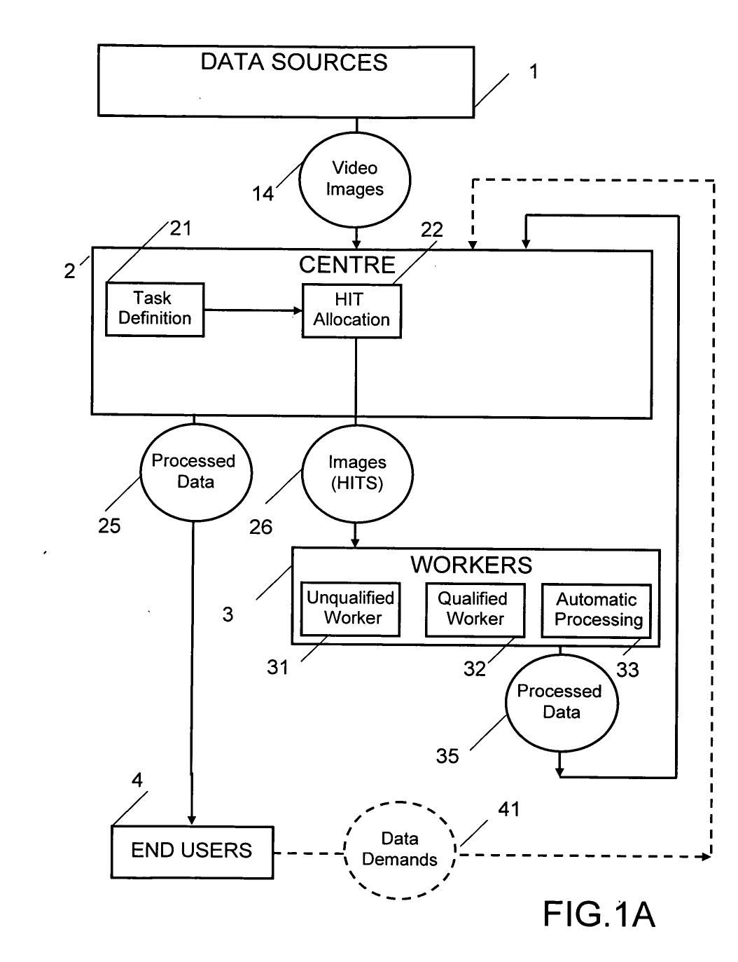

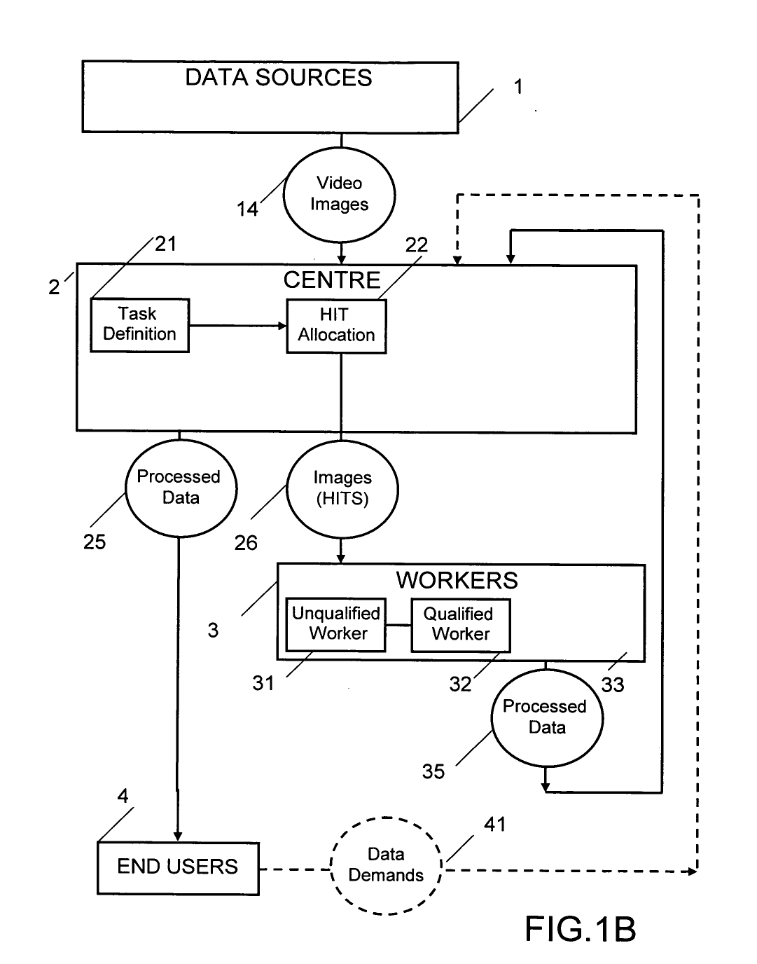

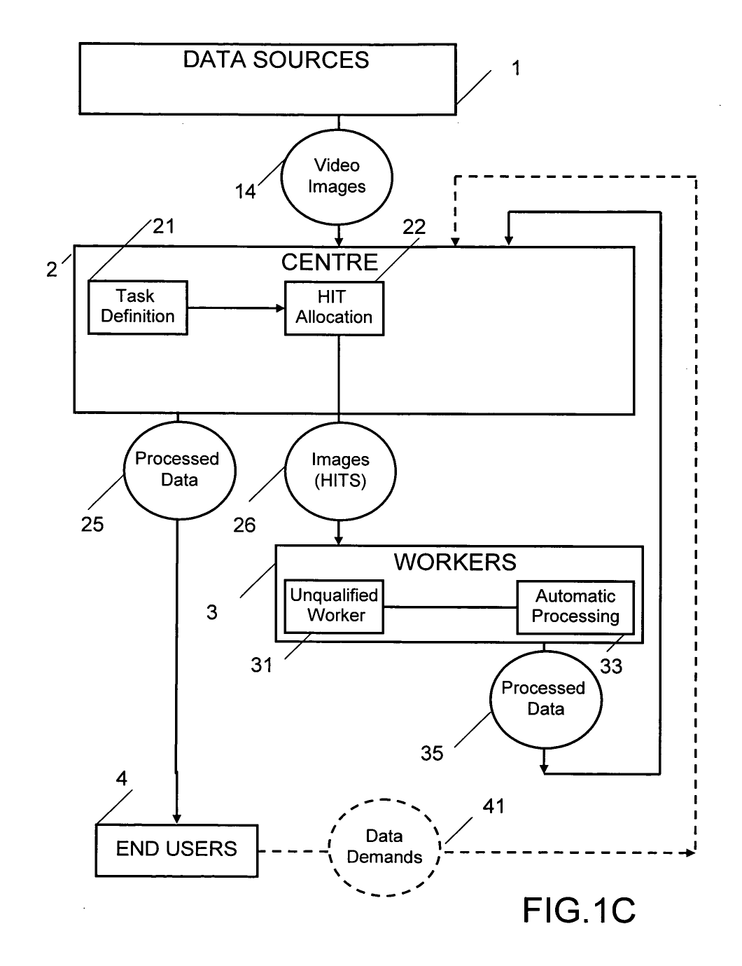

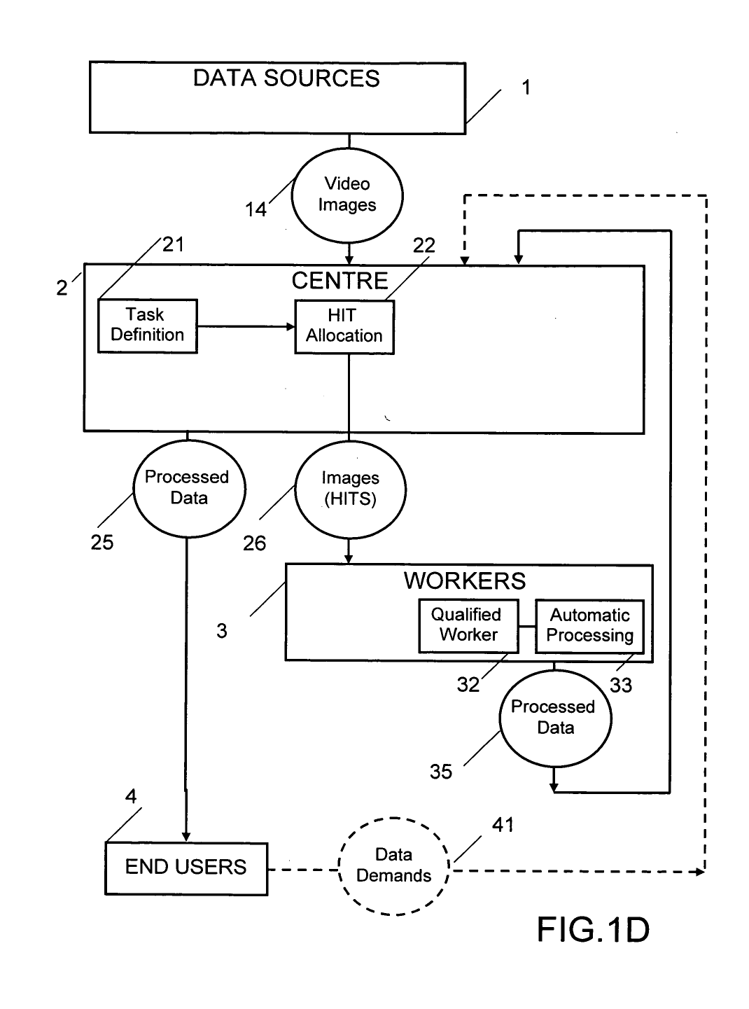

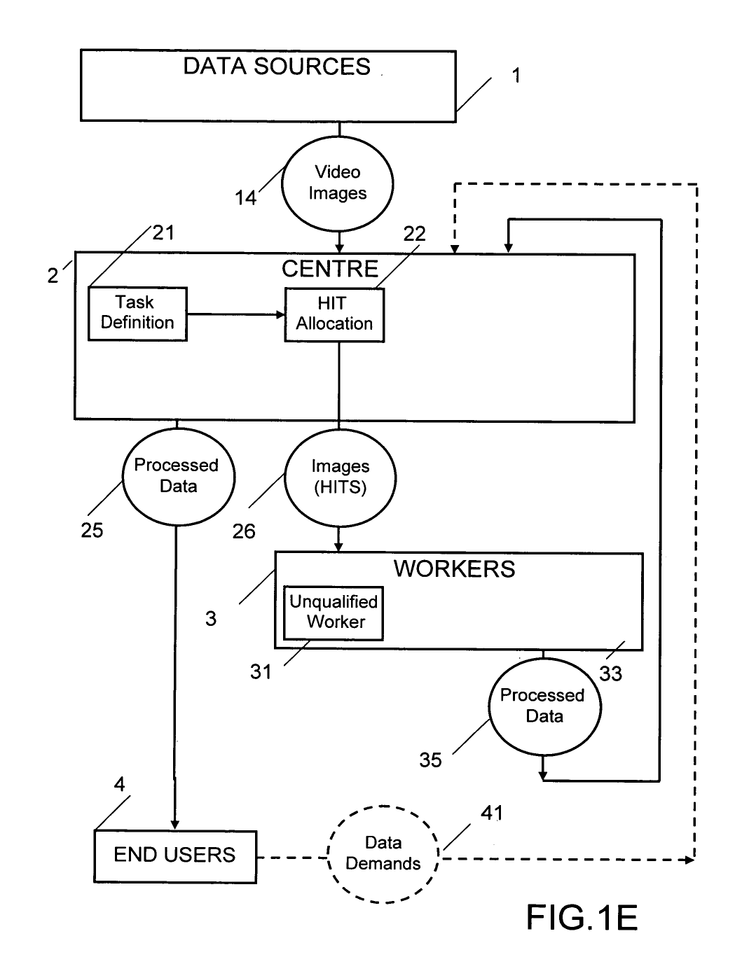

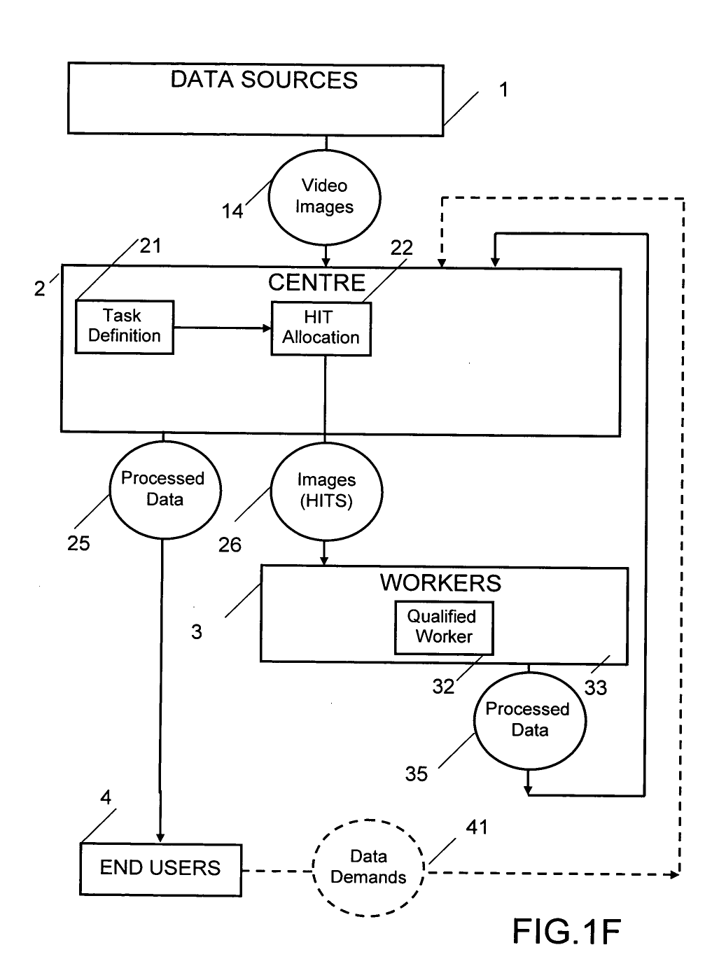

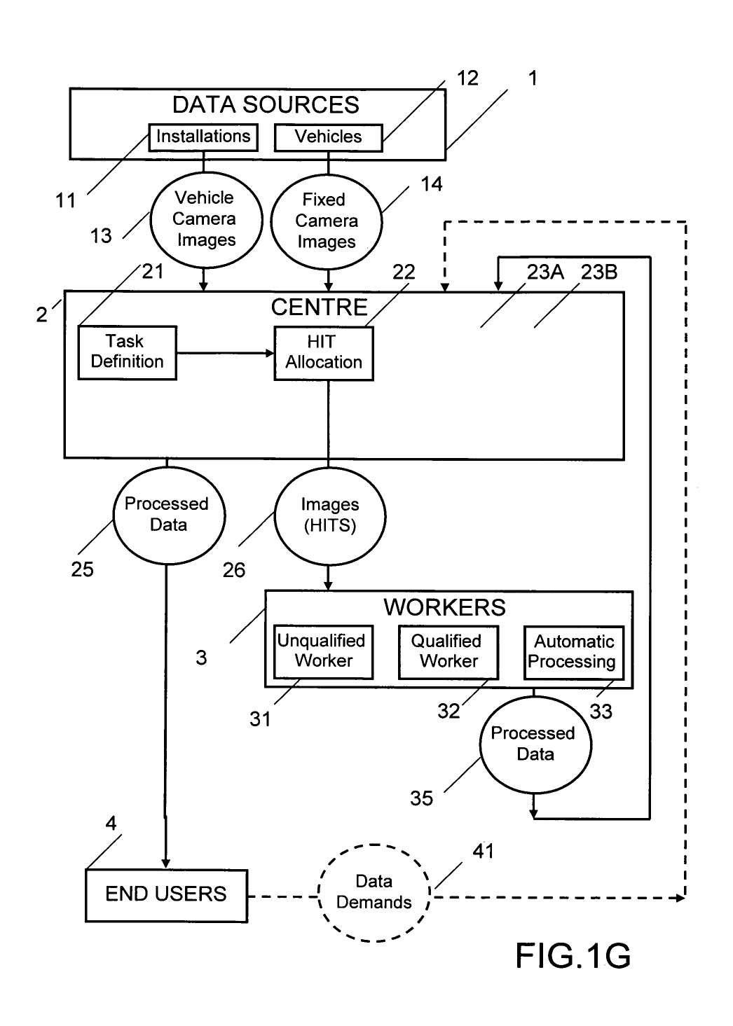

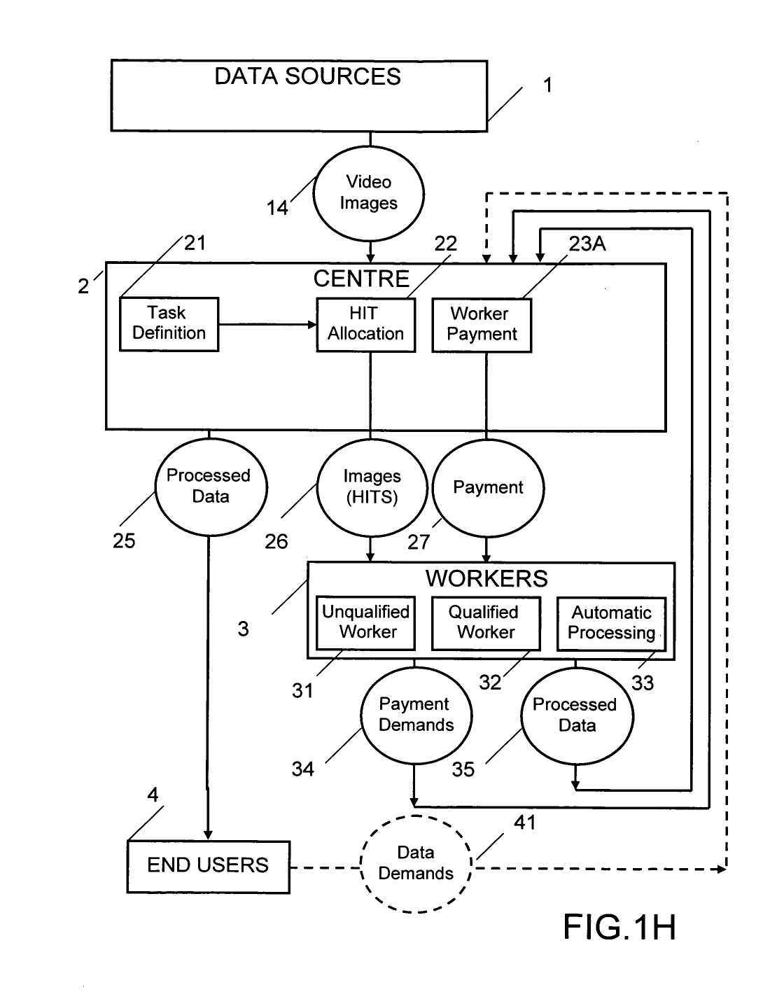

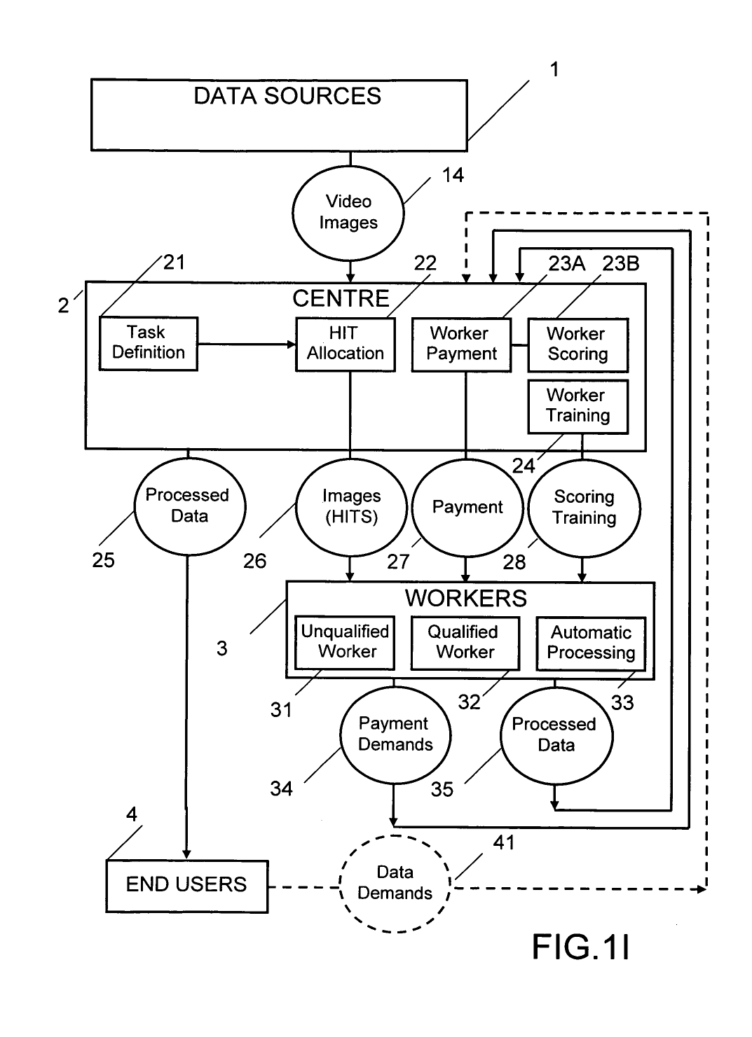

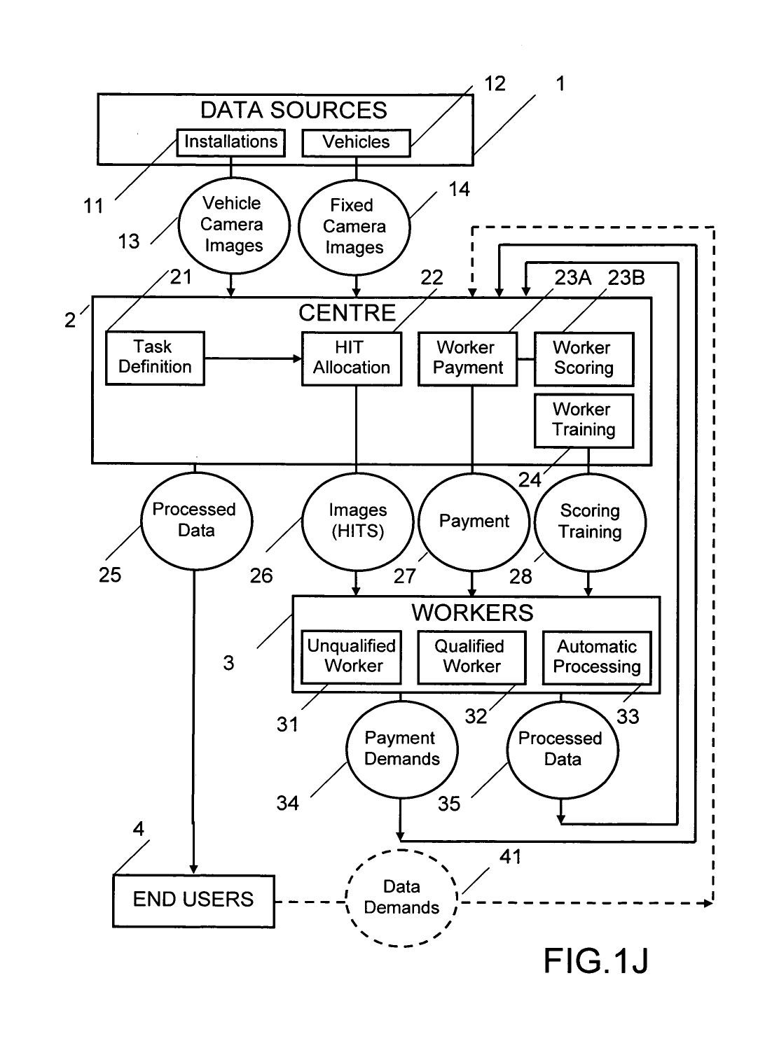

The basic principles of invention will be explained initially with reference to the flow diagrams of FIGS. 1A-1J

FIG. 1A is a flow diagram illustrating the general principles of a first embodiment of the invention. The key entities in the process are the video data sources 1, centre 2, workers 3 and end users 4. Workers are human operators equipped with computer workstations. The boxes represent entities. The circles represent data transferred.

The video data source transmits video data 14 to a centre 2. The scene depicted in any given video frame may contain several objects of interest disposed therein. Specifically, the input data comprises image frame data depict roadside scenes as recorded from a vehicle navigating said road or from a fixed camera installation. The input video data may have been recorded at any time and may be stored in a database of video sequences at the centre. In certain embodiments of the invention the video may be supplied to the centre on demand. In one embodiment of the invention the input video sequence may be digitized prior to delivery to the centre. In one embodiment of the invention the input video sequence may be digitized at the centre.

The centre 2 is essentially a facility that acts as a central coordinating server for defining and coordinating sub tasks that are dispatched to personal computers operated by humans. Specifically, the centre 2 is responsible for task definition 21, Human Intelligence Task (HIT) allocation 22. The centre may be a business entity or some other type organization employing suitably qualified humans to perform one or more of the above functions. Some of the above processes may be implemented on a computer. In certain embodiments of the invention the centre may be a computer programmed in such a way that all of the above functions may be performed automatically.

The centre transmits sequences of video data configured as HITs 26 to workers 3 for processing. The workers perform the HITs and deliver the results indicated by 35 to the center. The HITs may include descriptions of specific output required, the output format and the task definition and other information. In one embodiment of the invention a HIT may be associated with multiple attributes related to performance of the HIT. The attributes may include an accuracy attribute, a timeout attribute, a maximum time spent attribute, a maximum cost per task attribute, a maximum total cost attribute and others. The centre receives the responses and generates a result for the task based at least in part on the results of the workers activities.

In certain embodiments of the invention the dispatching by the centre of HITs to workers computer systems is performed using a defined application-programming interface.

The workers may comprise unqualified workers 31 and qualified workers 32. For the purposes of the invention an unqualified worker may be one of university educated, at most secondary school educated, and not formally educated. A qualified worker may be educated to any of the above levels but differs from an unqualified worker in respect of their relative expertise at performing the image analysis tasks at which the present invention is directed. Where the center is a business entity qualified workers would typically be employees of said business entity.

In one embodiment of the invention qualified workers may be based at the centre while unqualified workers operate remotely from any location that provides computer access to the centre. The qualified workers may perform similar task to those carried out by the unqualified workers. However, advantageously, the skills of the qualified workers are deployed to greater effect by engaging them in more specialist functions such as checking data, processing data delivered by the unqualified workers provide higher level information as will be discussed below. In certain embodiments of the invention the workforce may be comprised entirely of unqualified workers. In one embodiment of the invention the centre is a business entity and the workers are employees thereof. In such embodiments of the invention workers carry out tasks as part of their normal duties without requiring payment for said tasks.

Typically the processed data may be transmitted to end users 4 in response to data demands 41 transmitted by the end user to the centre. The end user data typically comprises requests for surveys of particular locations containing signs or other objects of interest. In certain embodiments of the invention the centre may function as the end user.

In the embodiment of FIG. 1A the workers work in association with automatic processing facilities 33 at the centre to provide a hybrid human/computer image processing facility. A preferred computer image processing facility and algorithms used therein is described in the co-pending United Kingdom patent application No. 0804466.1 with filing date 11 Mar. 2008 by the present inventor, entitled “METHOD AND APPARATUS FOR PROCESSING AN IMAGE”.

Further embodiments of the invention are illustrated in the flow diagrams provided in FIGS. 1B-1F where it should be noted that the embodiments of FIGS. 1A-1F differ only in respect of the organisation of the workers 3.

In the embodiment of FIG. 1A the workers 3 comprise unqualified workers 31 and qualified workers 32 working in association with automatic processing facilities 33 at the centre

In the embodiment of FIG. 1B the workers comprise unqualified workers 31 working in association with qualified workers 32.

In the embodiment of FIG. 1C the workers comprise unqualified workers 31 working in association with automatic processing facilities 33 at the centre

In the embodiment of FIG. 1D the workers comprise qualified workers 32 working in association with automatic processing facilities 33 at the centre

In the embodiment of FIG. 1E the workers comprise unqualified workers 31 only.

In the embodiment of FIG. 1F the workers comprise qualified workers 32 only.

In the embodiment of FIG. 1G, which is similar to the embodiment of FIG. 1A, video data may be collected as video recorded from a vehicle containing at least two cameras 11. Alternatively the video data may be obtained from fixed cameras 12.

In the embodiment of FIG. 1H, which is similar to the embodiment of FIG. 1A, the centre further comprises the functions of worker payment 23A. The center provides payments 27 to the workers 3. Payments are made in response to payment demands indicated by 34 transmitted to the center by the workers on completion of a HIT. In some cases the payments may be made automatically after the centre has reviewed the result of the HIT. The payment structure may form part of the HIT. The invention does not rely on any particular method for paying the workers.

In the embodiment of FIG. 1I which is similar to the embodiment of FIG. 1A the center further comprises the functions of worker training 23, worker payment 24 and worker scoring 25 The center assesses the performance of individual workers as indicated by 28. This may result in a weighting factor that may impact on the pay terms or the amount or difficulty of the work to be allocated to a specific worker. Yet another function of the center also represented by 28 may be the training of workers. The invention does not rely on any particular method for weighting the performance of workers.

In the embodiment of FIG. 1J all of the features of the embodiments of FIGS. 1A-1I are provided.

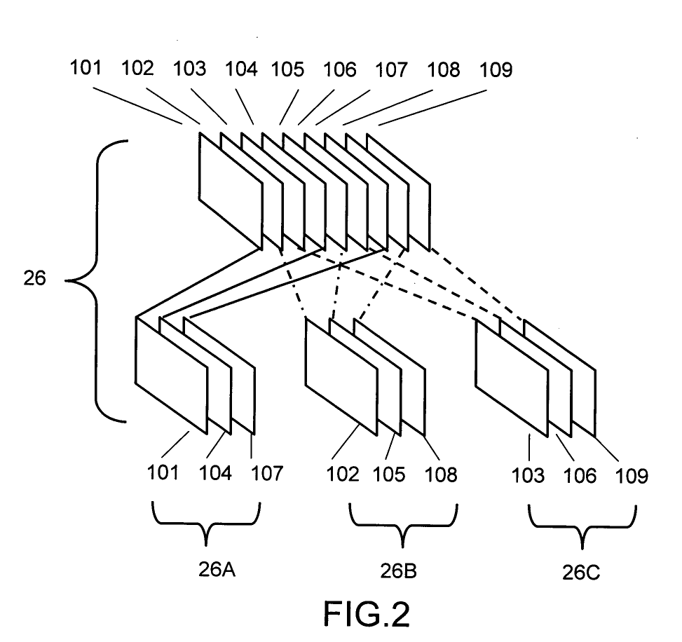

The details of the processing of the video data will now be discussed in more detail. FIG. 2 illustrates in schematic form how an input video sequence provided by any of the sources described above is divided into sub groups of video frames for distribution as HITs 26. As indicated in FIG. 2, the input image data comprises the set of video frames 101-109.

The input video frames are sampled to provide temporally overlapping image sequences such that each worker analyses data spanning the entire video sequence. For example, a first worker receives the image set 26A comprising the images 101,104,107. A second worker receives the image set 26B comprising the images 102,105,108. A third worker receives the image set 26C comprising the images 103,106,109.

Typically, the number of video frames will be much greater than indicated in FIG. 2. In a typical road survey application video frames are recorded approximately every two metres along a designated route. A typical video sample may contain 10,000 images. Images of interest may contain features such as signs, roadside equipment, manholes etc. Typically, digital capture rates for digital moving cameras used in conjunction with the present invention are thirty frames per second. The invention is not restricted to any particular rate of video capture. Faster or substantially slower image capture rates can be successfully used in conjunction with the present invention, particularly if the velocity of the recording vehicle can be adapted for capture rates optimized for the recording apparatus.

Advantageously, each video frame is associated with location and time data such that the 3D position of the object of interest may be located later. Said location data source may provide absolute position via Global Positioning System (GPS) or Differential Global Positioning System (d-GPS) transponder/receiver, or relative position via Inertial Navigation System (INS) systems, or a combination of GPS and INS systems.

In the next stage of the process the workers examines their allotted frames, recording each detection of an object of interest. The frames may be examined in time order but not necessarily.

Typically, the examination of the images relies on frames being presented in sequence on a computer screen with objects of interest being selected by the worker by performing a series of point and click operations with a mouse. A single click corresponds to a recorded detection. If an object of interest is not found in a frame the worker records the absence of the object by selecting an icon representing said object from a menu of objects of interest. Alternatively, said menu may provide a list of objects of interest. Desirably, said menu would be displayed alongside the video frame. Other methods of identifying and selecting objects of interest or registering the absence of an object of interest may be used as an alternative to mouse point and click. For example, in certain embodiments of the invention touch screens may be used.

The analysis has two objectives, firstly to determine the 3D location coordinates of a specified type of object and secondly to determine the attributes of said object.

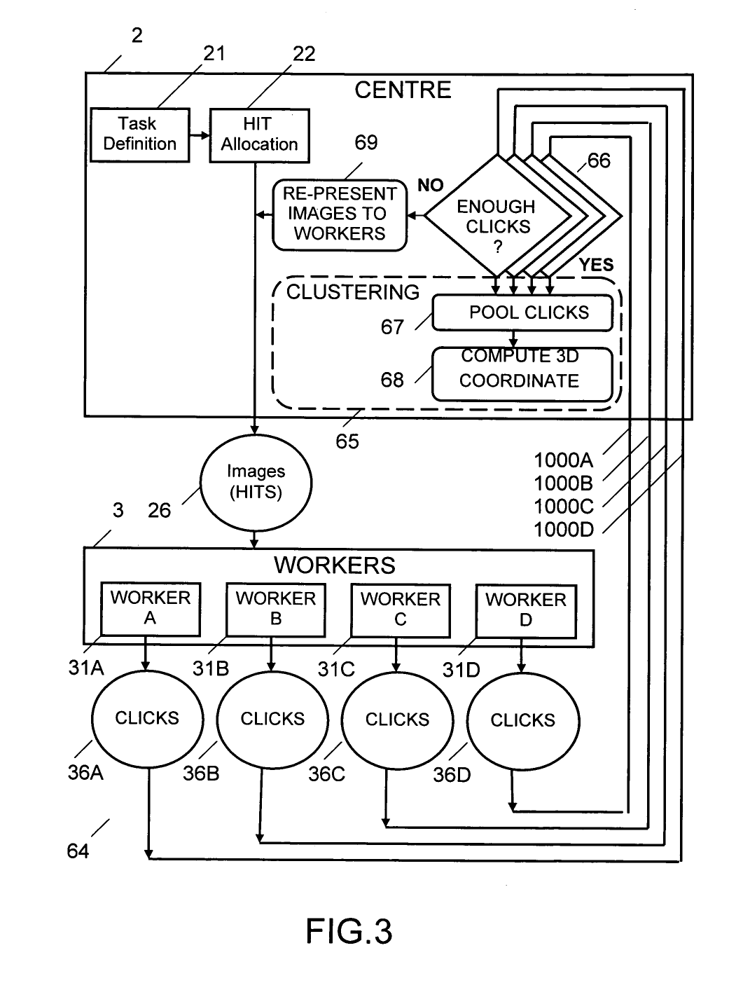

The process used to determine the 3D location of an object is illustrated using the flow diagram in FIG. 3, which shows the flow of data between the centre and the workers. Firstly, the centre 2 provides a task definition 21 followed by a HIT allocation 22. The input image frames are divided into HITs comprising images 26 according to the principle illustrated in FIG. 2. Said HITs may be accompanied by instructions for carrying out the task if the workers have not been briefed in advance.

The workers 31A-31D next proceed to scrutinize the video samples accumulating clicks indicated by 36A-36D when objects of interest are detected. Each click is suitably encoded and associated with data labelling the worker, video frame number, click time, and other data is transmitted to the centre via communication links indicated by 1000A-1000D. Desirably said communication links are provided by the Internet.

The next stage of the analysis is a clustering process wherein detections from multiple workers are pooled to determine whether they relate to a common 3D point characterizing the location of an object of interest. The clustering process takes place at the center and is represented by the box 65 delineated in dashed lines. The motivation for the clustering process is to achieve a high degree of confidence in the determination of a 3D point and to minimize the impact of false detections by one or more workers. Clustering in its simplest sense involves counting the number of detections accumulated by the workers within a specified interval (or series of video frames) within which the detection of a specified object may be expected to occur. Clustering may be performed automatically by a computer using data collected from the workers. Alternatively, trained workers at the centre may perform clustering. In certain embodiments of the invention clustering may be performed using a hybrid automatic/manual process.

The data received from each worker is monitored 66 to determine whether an adequate number of detections are being accumulated. The clustering process assumes that the workers, whether individually or collectively, will provide a specified number of detections for each object. At high video sampling rates a given object may occur in several sequential frames providing the opportunity for detection by more than one worker. If the video sampling rate is low the object will only appear in a few frames and determination of its 3D location may rely on one worker detecting said object. For intermediate video rates it is likely that more than one worker will detect a given object and any given worker may detect the object in more than one frame presented with the HIT. If the number of detections is satisfactory the data is pooled with the data accumulated by other workers indicated by 67. Finally, a 3D point is computed as indicated by 68. The invention does not rely on any particular method for determining the coordinates of the 3D point. Desirably, the 3D point computation is based on triangulation calculations using detections from more than one frame. If the object only appears in one frame it will not be possible to perform triangulation. In this case the calculation would be based on independently collected location data. Where multiple cameras are used to collect the video data triangulation methods well known to those skilled in the art may be used.

In the event of insufficient detections being accumulated by one or more workers, data is re-presented as a further HIT as indicated by 69.

In practice, the requisite number of detections required for determining a 3D point to the required confidence level may not be achieved due to missed detections by one or more workers. Such missed detections may arise from a lapse in concentration, inadequate understanding of the HIT requirement, corruption of video data or other causes. If insufficient detections are accumulated for a given object the data is returned to the centre and re-presented to a different worker. In certain embodiments of the invention data may be represented to more than one worker. Information relating to the representation of data for example the number of times data is presented, details of the object missed and other data may be stored at the centre for the purposes of applying efficiency weightings to the workers. If there are still insufficient detections the data is deemed false. If the number of detections increases the data is deemed valid.

From the above description it will be appreciated that the clustering processes used in the invention provides a means for determining the 3D location of an object to a high degree of confidence. It should also be appreciated that the clustering method provides a means for overcoming the problem of missed detections. It will further be appreciated that the invention provides a means for monitoring the efficiency of workers and providing information that may be used in weighting the remuneration of workers.

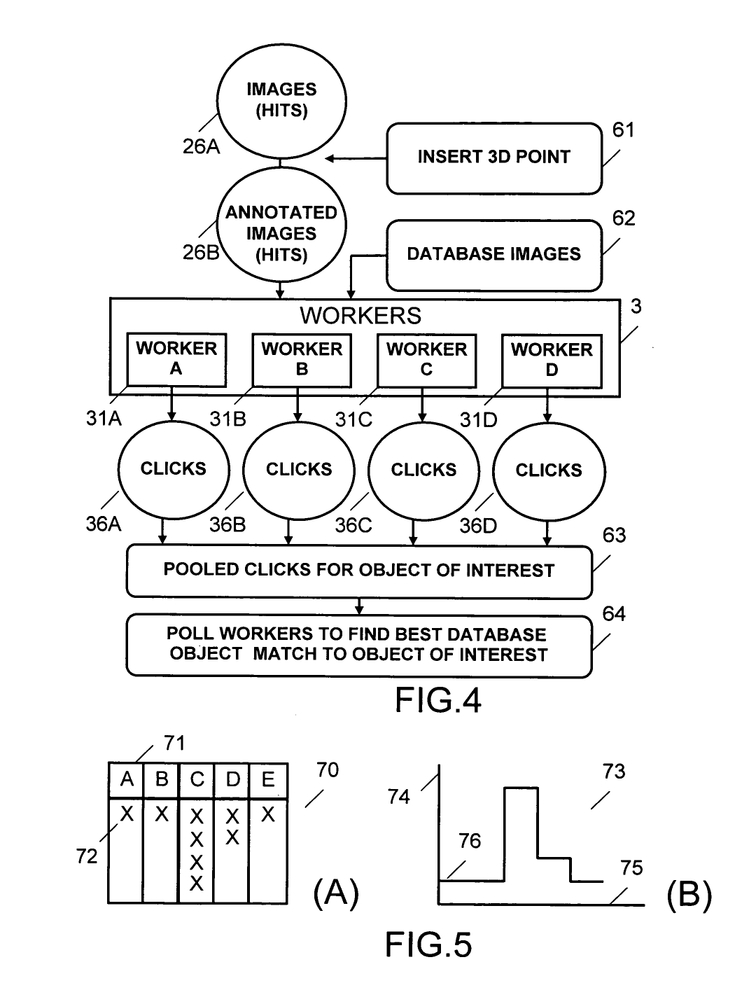

In another aspect of the invention illustrated in FIG. 4 there is provided a means for determining the attributes of the object that exists at the 3D point determined using the above-described process. For the purposes of the present invention an attribute may be understood to mean the type, category, geometry etc. of the object of interest.

The centre annotates each frame 26A deemed to contain objects of interest by inserting a symbol at an image point corresponding to the computed 3D point as indicated by 61. The centre then configures the annotated frames 26B as a second set of HITs for distribution to a group of workers 3. The second set of HITs is despatched to the workers together with a database of sign images 62, which is displayed within a menu at the workstation of each worker. The object may be compared with specific signs from a traffic sign reference such as the Traffic Signs Manual published by the United Kingdom Department for Transport. The Traffic Signs Manual gives guidance on the use of traffic signs and road markings prescribed by the Traffic Signs Regulations and covers England, Wales, Scotland and Northern Ireland. In certain embodiments of the invention the object may be assessed for membership of a particular class of signs and/or membership of a class of signs within a hierarchy of signs.

The workers comprise the workers 31A-31D. In certain embodiments of the invention the same workers may be used for the detection of objects and the assignment of attributes to objects. In certain embodiments the assignment of attributes may be carried out by different set of workers to avoid any image interpretation bias. In other embodiments qualified workers at the centre may carry out the assignment of attributes.

As each frame is presented each worker clicks on the database image that most closely matches the object in each annotated frame, each said click being recorded at the centre. The database selections signified by clicks 36A-36D are pooled 63 for each annotated frame object and then analysed 64 to identify the database image with the highest number of votes. The process of determining the vote counting process may be carried out using a computer program. Alternatively, the process may be carried out manually by workers at the center using data representation techniques such as the ones illustrated schematically in FIGS. 51-5B. As in indicated in FIG. 5A the votes of the workers may accumulated in a table such as 70 tabulating votes 72 for each database image 71. Alternatively, data may be presented visually as a histogram 73 of votes 74 versus database image 75 as indicted in FIG. 5B.

Finally the attributes of the highest vote scoring database image are assigned to each annotated frame object.

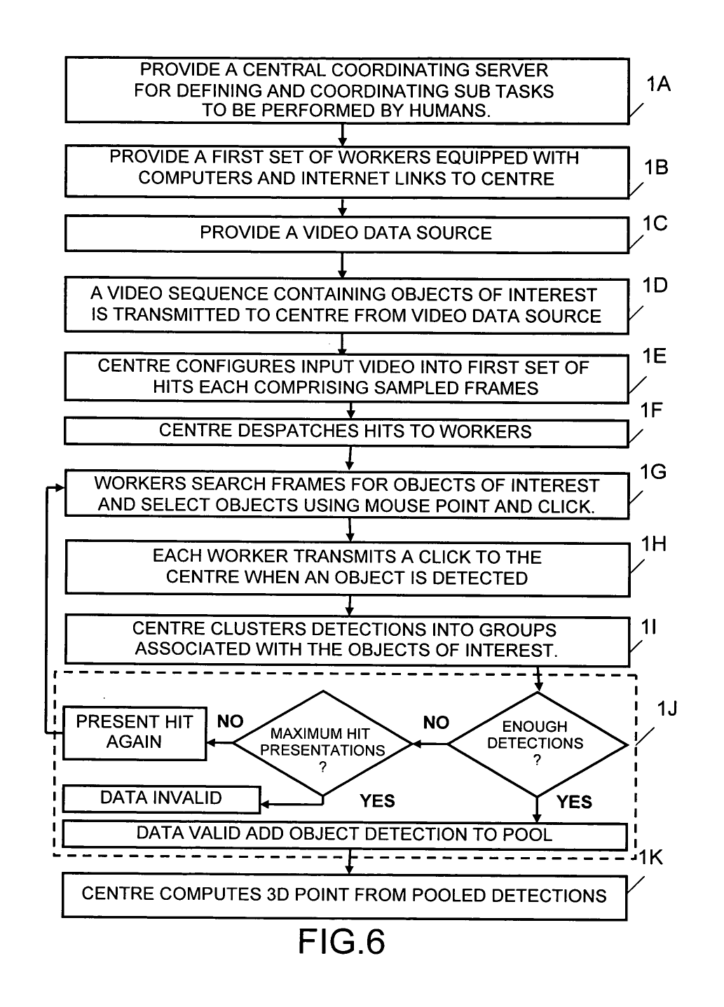

A method of detecting objects in a video sequence in accordance with the basic principles of the invention is shown in FIG. 6. Referring to the flow diagram, we see that the said method comprises the following steps.

At step 1A a centre comprising a central coordinating server for defining and coordinating sub tasks to be performed by humans is provided.

At step 1B a first set of workers comprising humans each equipped with computer workstations and linked to said center via the Internet is provided.

At step 1C a video data source is provided.

At step 1D an input video sequence containing images of objects of interest is transmitted to the centre from the video data source

At step 1E the centre configures the input video sequence into a first set of HITs each said HIT comprising a set of frames sampled from the input video sequence.

At step 1F the centre despatches said HITs to the workstations of said workers.

At step 1G each worker searches their allotted set of frames one frame at a time for objects of interest defined by the centre said objects being selected using a mouse point and click operation.

At step 1H each worker transmits a click to the centre when an object of interest is detected said click signifying an object detection.

At step 1I the centre clusters said detections into groups of detections associated with objects of interest.

At step 1J if a predetermined number of detections has not been achieved following presentation of HITs to one or more workers, the center re-transmits said HITs to one or more other workers, said other workers repeating steps 1G-1I until either the requisite number of click has been achieved, in which case the object detection is deemed valid, or the number of presentations of the HITs exceeds a predefined number, in which case the object detection is deemed invalid.

At step 1K the centre computes 3D location coordinates for each object detected using the pooled set of detections collected by the workers.

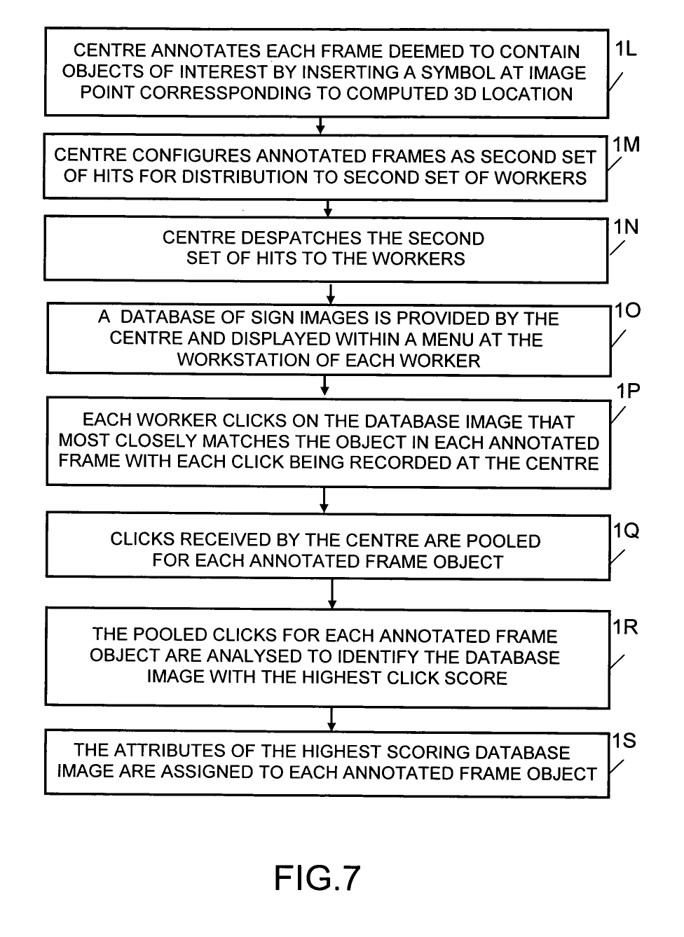

A method of assigning attributes to the objects detected using the steps illustrated in FIG. 6 in accordance with the principles of the invention is shown in the flow diagram in FIG. 7. Referring to the flow diagram, in which the step labels follow on from the ones used in FIG. 6 we see that the said method comprises the following steps.

At step 1L the centre annotates each frame deemed to contain objects of interest by inserting a symbol at an image point corresponding to the computed 3D location computed at step 1K.

At step 1M the centre configures the annotated frames as a second set of HITs for distribution to a second set of workers.

At step 1N the centre the second set of HITs is despatched to the workers.

At step 1O a database of sign images is provided by the centre and displayed within a menu at the workstation of each worker.

At step 1P each worker clicks on the database image that most closely matches the object in each annotated frame, each said click being recorded at the centre, each click signifying a database image selection.

At step 1Q database image selections received by the centre are pooled for each annotated frame object

At step 1R the pooled database image selections for each annotated frame object are analysed to identify the database image with the highest score.

At step 1S the attributes of the highest scoring database image are assigned to each annotated frame object.

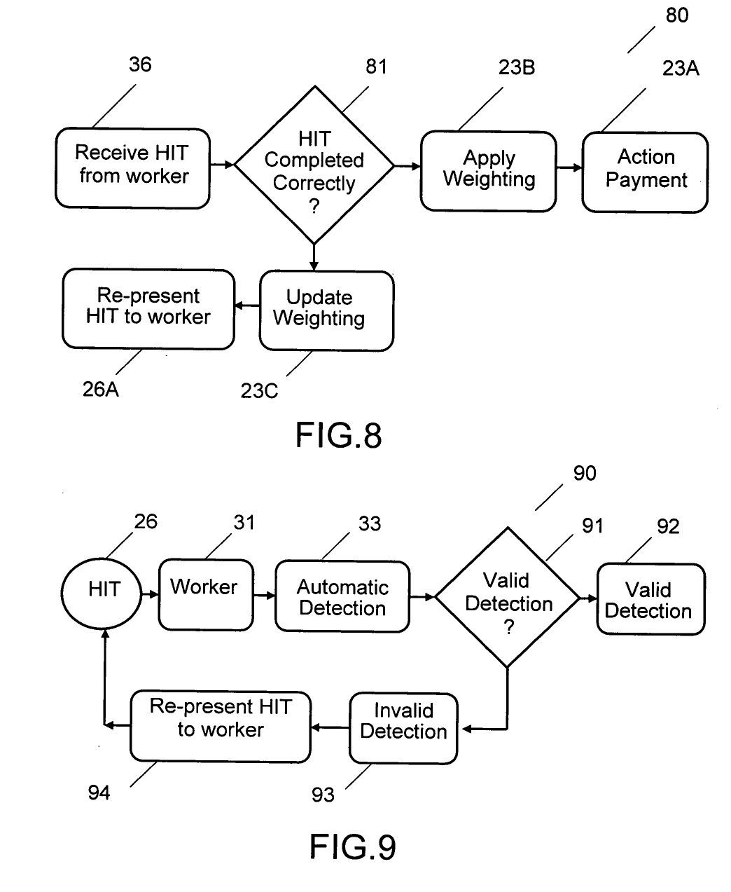

FIG. 8 is a flow diagram representing worker remuneration and scoring process 80 for use with the present invention and in particular with the embodiments of FIGS. 1I-1J. FIG. 8 is meant to illustrate one particular example of a scheme for remunerating and scoring workers. The invention is not limited to any particular method of remunerating and scoring workers.

In FIG. 8 the centre receives HIT results 36 from a worker. The results of the HIT are tested (81). If the HIT has been performed satisfactorily the centre simultaneous pays (23A) and scores (23B) the worker. The worker score is saved and used for weighting the worker. If the HIT is not deemed satisfactory the weightings are adjusting accordingly (23C) and the HIT may be re-presented (26A) to the worker. If the HIT is re-presented more than a predefined number of time the HIT may be rejected and any object detections resulting from the HIT deemed invalid.

Where special skills are required to complete HITs, the centre may qualify the workforce. In certain cases workers may be required to pass a qualification test. Alternately, workers may need to completed a minimum percentage of their tasks correctly or a minimum number of previous HITs in order to qualify. The same procedures can be used to train the workforce.

The invention does not rely any particular method of remunerating the worker. Indeed in certain cases where the worker is employed at the centre there is no requirement for special remuneration in relation to performance of HITs. The following embodiments are examples of remuneration methods that may be used with the invention.

In one embodiment of the invention a HIT includes providing an indication to the worker of the payment to be provided for performance of the HIT subtask if the worker chooses to perform the HIT.

In certain embodiments of the invention payment is provide on receiving from the work the first result of the performance of the HIT.

In certain embodiments of the invention payment is provide on receiving from the work the final result of the performance of the HIT.

In certain embodiments of the invention payment of a worker is based at least in part on the quality of the performance of the HIT by the worker.

In certain embodiments of the invention payment is based at least in part on a weighting based on the past quality of the performance of the worker In certain embodiments of the invention the HIT includes providing an indication to the worker of compensation associated with performance of the HIT.

In one embodiment of the invention the centre is a business entity and the workers are employees thereof. In such embodiments of the invention workers carry out tasks as part of their normal duties without requiring payment for said tasks.

In one embodiment of the invention the allocation of HITs to individual workers may be determined by the quality of performance of earlier HITs by said worker.

FIG. 5 is a flow diagram representing a process 90 in which a HIT 26 is performed by a worker 31 and an automatic processor 33 according to the principles of the embodiments of FIGS. 1A-1J. In the embodiment of FIG. 9 the worker is unqualified. However in other embodiments the worker may be qualified worker 32. The results of the HIT are tested 91 and deemed valid 92 if the HIT requirement is met. If the results are deemed invalid 93 the HIT is fed back to the start of the process for re-examination 94

Although the invention has been discusses in relation to processing video data, the invention may be used to process other types of input images. In alternative embodiments of the invention pre-recorded set of images, or a series of still images, or a digitized version of an original analog image sequence may be used to provide the input images. In certain embodiments of the invention photographs may be used to provide still images. If the initial image acquisition is analog, it must be first digitized prior to subjecting the image frames to analysis in accordance with the invention.

The present invention is not restricted to any particular output. The invention creates at least a single output for each instance where an object of interest was identified. In further embodiments of the invention the output may comprise one or more of the following: location of each identified object, type of object located, entry of object data into an GIS database, and bitmap image(s) of each said object available for human inspection (printed and/or displayed on a monitor), and/or archived, distributed, or subjected to further automatic or manual processing.

Sign recognition and the assignment of attributes to objects by workers may be assisted by a number of characteristics of road signs. For example, road signs benefit from a simple set of rules regarding the location and sequence of signs relative to vehicles on the road and a very limited set of colours and symbology etc. The aspect ratio and size of a potential object of interest can be used to confirm that an object is very likely a road sign.

The present invention is not restricted to the detection of roadside equipment, installations and signs. The basic principles of the invention may also be used to recognize, catalogue, and organize searchable data relating to signs adjacent to railways road, public rights of way, commercial signage, utility poles, pipelines, billboards, man holes, and other objects of interest that are amenable to video capture techniques.

The present invention may also be applied to the detections of other types of objects in scenes. For example, the invention may be applied to industrial process monitoring and traffic surveillance and monitoring.

Although the present invention has been discussed in relation to video images, the invention may also be applied using image data captured from still image cameras using digital imaging sensors or photographic film.

The present invention may be applied to image data recorded in any wavelength band including the visible band, the near and thermal infrared bands, millimeter wave bands and wavelength bands commonly used in radar imaging systems.

Although the invention has been described in relation to what are presently considered to be the most practical and preferred embodiments, it is to be understood that the invention is not limited to the disclosed arrangements, but rather is intended to cover various modifications and equivalent constructions included within the spirit and scope of the invention without departing from the scope of the following claims.

What is claimed:

1. A method for using human assistance in processing video data comprising the steps of
a) providing a centre comprising a central coordinating server for defining and coordinating Human Intelligence Tasks (HITs);
b) providing a first set of workers comprising humans, wherein each said worker is equipped with computer workstations and linked to said centre via the internet;
c) providing a video data source;
d) said video data source transmitting an input video sequence comprising frames containing images of objects in a scene to said centre;
e) said centre defining objects of interest and configuring said input video sequence into a first set of HITs, wherein each HIT is allocated to a particular worker, wherein each said HIT comprises a set of frames sampled from said input video sequence;
f) said centre despatching said HITs to said workstations;
g) said workers searching their allotted set of frames one frame at a time for said objects of interest, said objects being selected using a computer data entry operation;
h) said workers each transmitting a signal signifying an object detection to said centre when an object of interest is detected;
i) said centre clustering said object detections into groups associated with said object of interest and deeming an object detection valid if a predetermined number of said object detections is collected;
j) in the event of one or more workers failing to deliver a predetermined number of object detections, said center re-transmitting HITs to other workers, said other workers repeating steps (f) to (j) until the requisite number of object detections has been achieved or the number of presentations of said HITs exceeds a predefined number, in which case the object detection is deemed invalid; and
k) said centre computing 3D location coordinates for each valid object detection.

2. The method of claim 1 further comprising the steps of;
l) said centre annotating each frame deemed to contain objects of interest by inserting a symbol at an image point corresponding to the location of each said object of interest;
m) said centre configuring the annotated frames as a second set of HITs for distribution to a second set of workers;
n) said centre despatching said second set of HITs to said second set of workers;
o) said centre providing a database of sign images that is displayed within a menu at the workstation of each worker;
p) said workers each clicking on the database image that most closely matches said annotated frame object, each said click being recorded at the centre, each said click signifying a database image selection;
q) said centre pooling database image selections received for each annotated frame object;
r) said centre analysing the pooled database image selections for each annotated frame object to identify the database image with the highest click score; and
s) said centre assigning the attributes of the highest scoring database image to each annotated frame object.

3. The method of claim 1 wherein said centre performs the functions of image processing task definition and HIT allocation.

4. The method of claim 1 wherein said centre performs the functions of image-processing task definition, HIT allocation and at least one of worker payment, worker scoring and worker training.

5. The method of claim 1 wherein said video data source comprises at least one vehicle mounted camera.

6. The method of claim 1 wherein said video data source comprises at least one fixed camera installation.

7. The method of claim 1 wherein said input video data source is a video database at said centre.

8. The method of claim 1 wherein said input video sequence divided into a multiplicity of video sub sequences sampled in such a way that each worker analyses frames spanning the entire video sequence, wherein each said video sub sequence is allocated to a separated worker.

9. The method of claim 1 wherein said video sequence is augmented with location data provided by at least one of Global Positioning System (GPS) or Differential Global Positioning System (d-GPS) transponder/receiver, or relative position via Inertial Navigation System (INS) systems, or a combination of GPS and INS systems.

10. The method of claim 1 wherein said computer data entry operation is a mouse point and click operation.

11. The method of claim 1 wherein said HITs comprise at least one video image frame.

12. The method of claim 1 wherein said HITs comprise video image frames annotated with information relating to the 3D locations of objects in scenes depicted in said frames.

13. The method of claim 1 wherein said workers comprises unqualified workers.

14. The method of claim 1 wherein said workers comprise qualified workers.

15. The method of claim 1 wherein said workers work in association with a computer image processing system.

16. The method of claim 1 wherein said analysis of pooled object detections is performed automatically.

17. The method of claim 1 wherein said centre is a business entity.

18. The method of claim 1 wherein said centre is a computer system.

19. The method of claim 1 wherein said objects of interest are road signs.

20. The method of claim 1 wherein said objects of interest are items of roadside equipment.

21. The method of claim 1, wherein said workers are one of university educated, at most secondary school educated, and not formally educated.

22. The method of claim 1, wherein said HIT is associated with multiple attributes related to performance of said task, the attributes comprising at least one of accuracy attribute, a timeout attribute, a maximum time spent attribute, a maximum cost per task attribute, and a maximum total cost attribute.

23. The method of claim 1 wherein the dispatching of HITs by the centre is performed using a defined application programming interface.

24. The method of claim 1 wherein the dispatching of HITs to workers includes providing an indication to the workers of the payment to be provided for performance of the HIT if the worker chooses to perform the HIT.

25. The method of claim 1 wherein the providing of the payment to the worker is performed in response to the receiving from the worker of the first result from the performance of the HIT.

26. The method of claim 1 wherein the payment provided to the worker for the performance of the HIT is based in part on quality of the performance of the HIT.

27. The method of claim 1 wherein the payment provided to the worker is based at least in part on the past quality of performance of HITs by the worker.

28. The method of claim 1 wherein the dispatching of the HIT to the worker includes providing an indication to the worker of compensation associated with performance of the HIT.

29. The method of claim 2 wherein said second set of workers may be identical to said second set of workers.

30. The method of claim 2 wherein said first set of workers is unqualified and said second set of workers is qualified.

31. The method of claim 2 wherein said attributes comprise matches to specific signs depicted in traffic sign reference manuals.

32. The method of claim 2 wherein said attributes comprise matches to specific signs depicted in the Traffic Signs Manual published by the United Kingdom Department for Transport.

33. The method of claim 2 wherein said attributes comprise membership of a particular class of signs.

34. The method of claim 2 wherein said attributes comprise membership of a class of signs within a hierarchy of signs.

35. The method of claim 1 wherein said data entry operation employs a touch screen.
